(19) United States
(12) Patent Application Publication
(10) Pub. No.: US 2020/0110160 A1
(43) Pub. Date: Apr. 9, 2020

(54) LIDAR WITH DYNAMICALLY VARIABLE RESOLUTION IN SELECTED AREAS WITHIN A FIELD OF VIEW

(71) Applicant: Quanergy Systems, Inc., Sunnyvale, CA (US)

(72) Inventors: Louay ELDADA, Sunnyvale, CA (US); Tomoyuki IZUHARA, Sunnyvale, CA (US); Tianyue YU, Sunnyvale, CA (US); Ross TAYLOR, Sunnyvale, CA (US)

(21) Appl. No.: 16/154,383

(22) Filed: Oct. 8, 2018

(51) Int. Cl. G01S 7/486; G01S 17/10; G01S 7/484

(52) U.S. Cl. CPC G01S 7/4865; G01S 7/484; G01S 17/10

(57) ABSTRACT

An apparatus has an optical phased array producing a far field electro-magnetic field defining a field of view. Receivers collect reflected electro-magnetic field signals characterizing the field of view. A processor is configured to process the reflected electro-magnetic field signals to identify a selected area in the field of view as an area of interest. The processor is further configured to dynamically adjust control signals applied to the optical phased array to produce an updated far field electro-magnetic field with increased electro-magnetic field resolution for the selected area.

### FIELD OF THE INVENTION

This invention relates generally to optical phased array systems, such as Time of Flight (ToF) lidar sensors for real-time three-dimensional mapping and object detection, tracking, identification and/or classification. More particularly, this invention relates to a lidar with dynamically variable resolution in selected areas within a field of view.

### BACKGROUND OF THE INVENTION

FIG. 1 illustrates a prior art optical phased array 100 with a laser source 102 that delivers optical power to waveguides 104_1 through 104_N, which are connected to phase tuners 106_1 through 106_N. The optical output of the phase tuners 106_1 through 106_N is applied to corresponding optical emitters 108_1 through 108_N.

Optical phased array 100 implements beam shaping. By controlling the phase and/or amplitude of the emitters 108_1 through 108_N, the electro-magnetic field close to the emitters, known as the near field, can be controlled. Far away from the emitters 108_1 through 108_N, known as the far field, the electro-magnetic field can be modeled as a complex Fourier transform of the near field. To achieve a narrow beam in the far field, a flat phase profile in the near field is required. The width of the array determines the width of the far-field beam, scaling inversely. The slope of the near field phase profile determines the output angle of the beam. This means that by phase tuning the emitters, beam steering is achieved.

The far field electro-magnetic field defines a field of view. A field of view typically has one or more areas of interest. Therefore, it would be desirable to provide techniques for dynamically supplying enhanced resolution in selected areas within a field of view.

### SUMMARY OF THE INVENTION

An apparatus has an optical phased array producing a far field electro-magnetic field defining a field of view. Receivers collect reflected electro-magnetic field signals characterizing the field of view. A processor is configured to process the reflected electro-magnetic field signals to identify a selected area in the field of view as an area of interest. The processor is further configured to dynamically adjust control signals applied to the optical phased array to produce an updated far field electro-magnetic field with increased electro-magnetic field resolution for the selected area.

### BRIEF DESCRIPTION OF THE FIGURES

The invention is more fully appreciated in connection with the following detailed description taken in conjunction with the accompanying drawings, in which:

FIG. 1 illustrates an optical phased array configured in accordance with the prior art.

FIG. 2 illustrates system configured in accordance with an embodiment of the invention.

FIG. 3 illustrates emitted signals produced in accordance with an embodiment of the invention.

FIG. 4A illustrates a sweep field produced in accordance with an embodiment of the invention.

FIG. 4B illustrates a sweep and focus fields produced in accordance with an embodiment of the invention.

FIG. 5 illustrates a frame produced in accordance with an embodiment of the invention.

FIG. 6 illustrates an end frame produced in accordance with an embodiment of the invention.

FIG. 7 illustrates a focused sweep field produced in accordance with an embodiment of the invention.

FIG. 8 illustrates a focused sweep frame produced in accordance with an embodiment of the invention.

FIG. 9 illustrates a sweep and focus frames produced in accordance with an embodiment of the invention.

FIG. 10A illustrates a sweep frame produced in accordance with an embodiment of the invention.

FIG. 10B illustrates a focus frame produced in accordance with an embodiment of the invention.

FIG. 11 illustrates emitted signals produced in accordance with an embodiment of the invention.

FIG. 12 illustrates emitted signals produced in accordance with an embodiment of the invention.

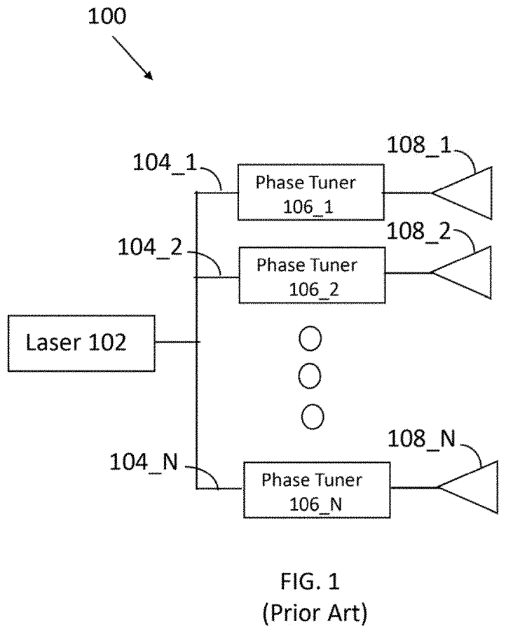

Like reference numerals refer to corresponding parts throughout the several views of the drawings.

### DETAILED DESCRIPTION OF THE INVENTION

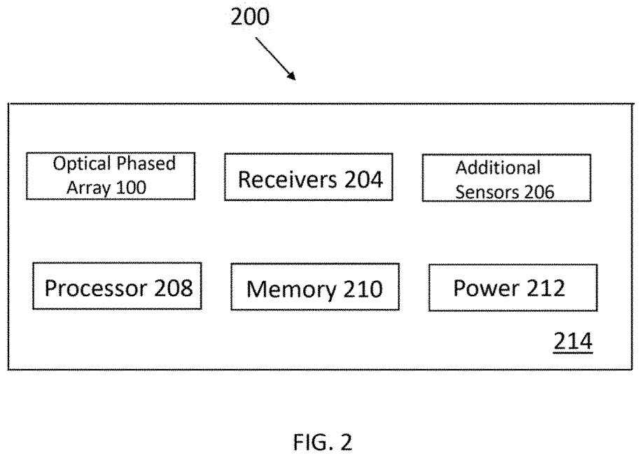

The optical phased array 100 is incorporated into a system 200 of FIG. 2 to implement operations disclosed herein. In particular, the system 200 includes optical phased array 100, receivers 204, additional sensors 206, a processor 208, memory 210, and power electronics 212 mounted on a printed circuit board 214.

The system 200 has an optical phased array 100 that produces a far field electro-magnetic field defining a field of view. Receivers 204 collect reflected electro-magnetic field signals characterizing the field of view. The processor 208 is configured to process the reflected electro-magnetic field signals to identify a selected area in the field of view as an area of interest. The processor 208 is further configured to dynamically adjust control signals applied to the optical phased array 100 to produce an updated far field electro-magnetic field with increased electro-magnetic field resolution for the selected area.

The processor 208 may be configured by executing instructions stored in memory 210. Alternately, the processor 208 may be a field programmable logic device or application specific integrated circuit with hardwired circuitry to implement the operations disclosed herein.

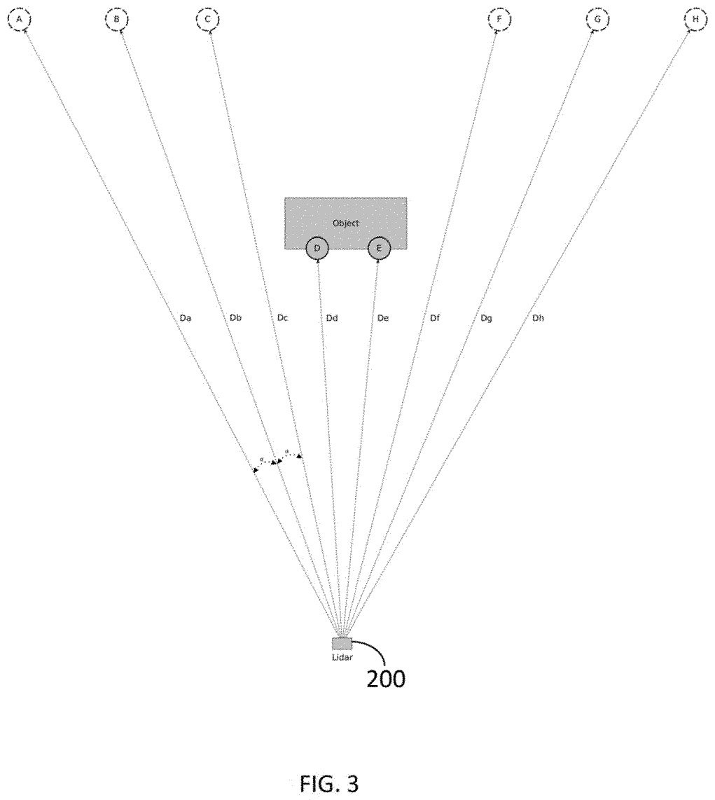

FIG. 3 illustrates system 200 scanning a far field from A to H at a constant rate of angular resolution (denoted in the figure as the angle α). The system 200 measures the time-of-flight for each firing and translates the time-of-flight into distance D. If, during this scan, a difference in distance is measured between two angular adjacent pulses, such as between point C and D in FIG. 3, the beam angles D and E are tagged as selected areas of interest. The difference in distance between two angular adjacent pulses may be compared to a threshold (e.g., a 10% difference in distance) to determine whether an area of interest exists. The difference in distance may be used to determine the size of the area of interest (e.g., a 25% or more difference in distance may result in the designation of more adjacent beams to the area of interest).

A firing is a single pulse or pattern of pulses emitted by the system 200. The system 200 measures the intensity of the return of the light bouncing off a reflective target. Once completed, the angle of the output shifts to the next value in its scan pattern. Firings are executed at a constant rate and take a constant amount of time to complete.

A frame is one full cycle of firings. Once complete, the pattern repeats itself. In one embodiment, a frame comprises a sweep field and a focus field. In one embodiment, a frame has a constant number of total firings and takes a constant amount of time to complete. A sweep field is a standard firing pattern with constant angular resolution between adjacent emitted signals. A focus field has additional emitted signals that are added to the sweep field based on an area of interest. The focus field has increased electro-magnetic resolution for the area of interest. The increased electro-magnetic resolution is attributable to an angular resolution between adjacent emitted signals that is less than the constant angular resolution used in the sweep field.

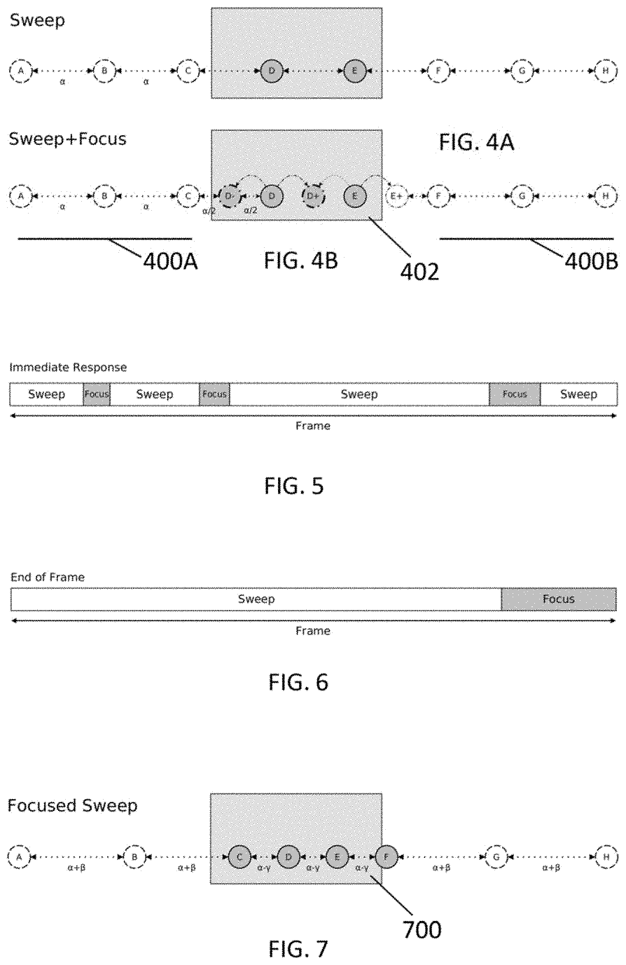

FIG. 4A illustrates a sweep field with constant angular resolution α. FIG. 4B illustrates a sweep field with sweep segments 400A and 400B with constant angular resolution α. The figure also illustrates a focus field 402 with an angular resolution of α/2. Observe that there is a difference in distance between firing C and firing D. Two focus firings are added (D− and D+) around firing D. For point E only the E+ is added because E− and D+ would be at the same location.

FIG. 5 illustrates an immediate response pattern formed in accordance with an embodiment of the invention. As soon as a difference in distance is measured, the system 200 fires additional beams around the area of interests at an angular resolution that is less than the constant sweep angular resolution. An example sequence is A B C D D− D+ E E+ F G H.

FIG. 6 illustrates an end of frame. After the sweep field scan is complete, the system 200 assigns focus firings to the areas of interest at the end of the current frame. An example pattern is A B C D E F G H D− D+ E+. Other techniques may be used such that focus firings are completed before the end of the frame. The angular resolution is not fixed to α/2; it may be as low as the hardware allows. For example, with an angular resolution of α/3, the pattern may be A B C D D −−D− D+ D++ E E+ E++F G H.

The sweep field and focus field within a frame have a ratio that is variable and dynamic. In one embodiment, the sum of the sweep field and focus field (i.e., a frame) is constant in both number of firings and total duration. If, for example, 100,000 firings exist in a frame, the ratio between the sweep field and focus field can be 80,000:20,000. The number of points assigned to the focus field is called the focus budget.

If no areas of interest exist, the system 200 may interlace focus beams at a constant interval throughout the scan frame. Alternately, the sweep-to-focus ratio may be increased (i.e., decrease the focus budget). This decreases the angular spacing between firings and thereby increases sweep angular resolution.

It should be appreciated that focus can exist in two dimensions, both left-to-right (horizontal dimension) and top-to-bottom (vertical dimension). Moreover, the focus pattern can be “random access” in the sense that it may be any arbitrary pattern, which includes and enables the disclosed variable resolution.

FIG. 7 illustrates a frame with a focused sweep field. The angular spacing in the area of interest 700 is α−y, which y can be any value between 0 and α. The angular spacing for the remaining frame is α+β, where β can be any value greater than 0. The exact value of y and β are a function of the total number of firings per frame, the total angular distance of the frame, and the size and number of areas of interest.

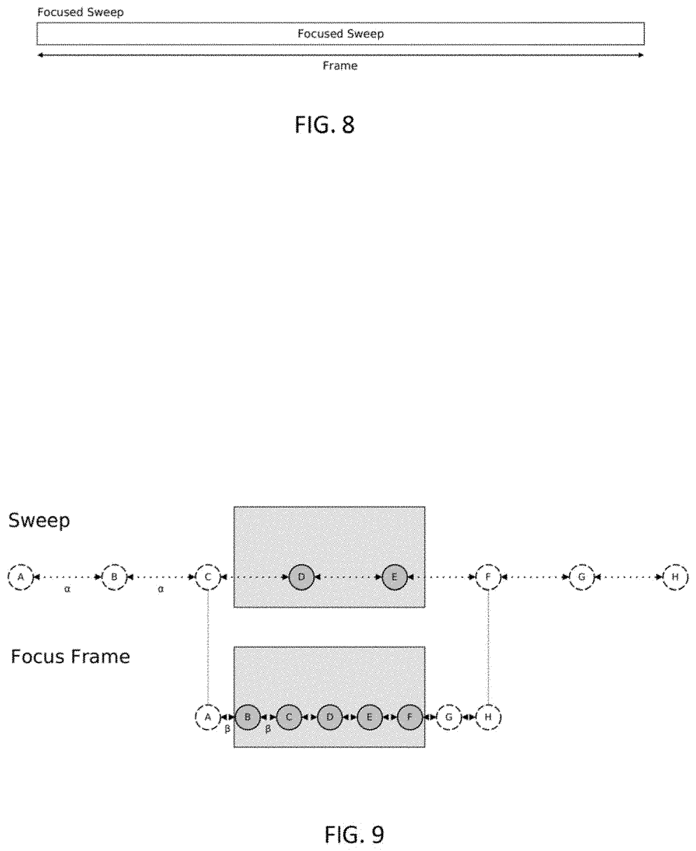

FIG. 8 illustrates a focused sweep frame produced in accordance with an embodiment of the invention. The total number of firings per frame is constant. Only the angular resolution is variable. Therefore, every focused sweep field is exactly one frame long and there is no distinction between an unfocused sweep field and a focused sweep field. The unfocused sweep field is merely a focused sweep field without any areas of interest.

FIG. 9 illustrates a sweep and focus frame produced in accordance with an embodiment of the invention. The sweep portion has an angular resolution of α, while the focus portion has an angular resolution of β.

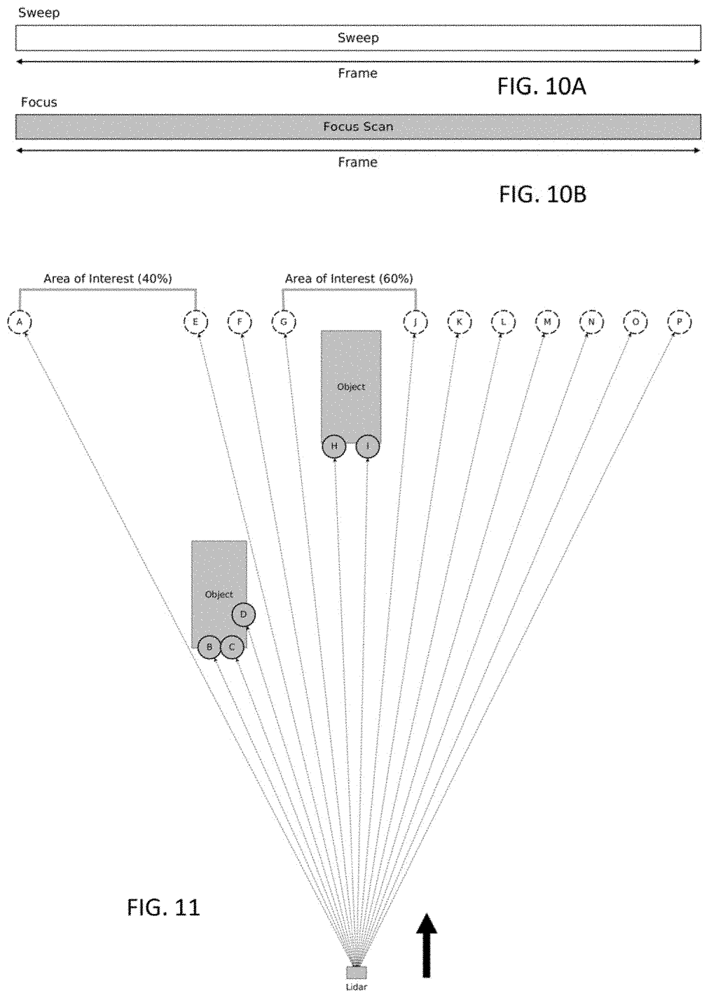

The system 200 may be configured to alternate between a standard sweep frame, such as shown in FIG. 10A and a focus frame, such as shown in FIG. 10B.

Once a sweep frame is complete, the point cloud is analyzed and each area of interest is assigned a piece of the focus budget. The size of each focus budget is determined as a function of the location of the object, relative velocity, size, historical data, classification, and the like. A newly detected object is assigned a large portion of the focus budget.

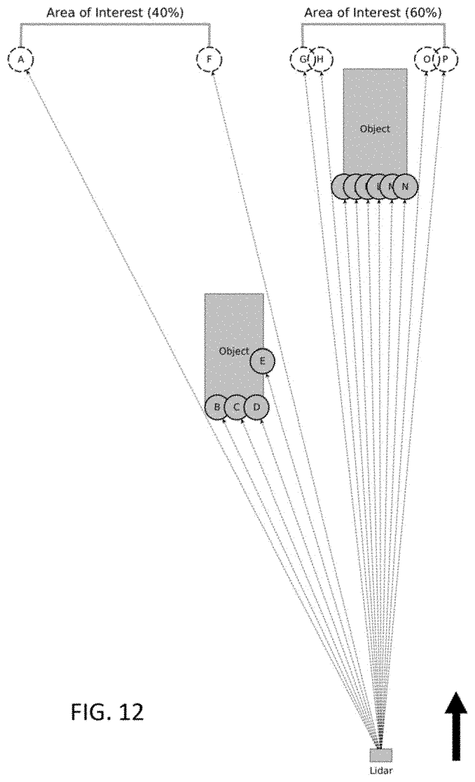

FIG. 11 illustrates a focus budget of 40% for a first area of interest and a focus budget of 60% for a second area of interest. FIG. 12 illustrates an alternate signal emission pattern for two areas of interest.

The invention can be used in connection with Time of Flight (ToF) lidar sensors for real-time three-dimensional mapping and object detection, tracking, identification and/or classification. A lidar sensor is a light detection and ranging sensor. It is an optical remote sensing module that can measure the distance to a target or objects in a scene by irradiating the target or scene with light, using pulses (or alternatively a modulated signal) from a laser, and measuring the time it takes photons to travel to the target or landscape and return after reflection to a receiver in the lidar module. The reflected pulses (or modulated signals) are detected with the time of flight and the intensity of the pulses (or modulated signals) being measures of the distance and the reflectivity of the sensed object, respectively. Thus, the two dimensional configuration of optical emitters provides two degrees of information (e.g., x-axis and y-axis), while the time of flight data provides a third degree of information (e.g., z-axis or depth).

Microfabrication and/or nanofabrication techniques are used for the production of an optical phased array photonic integrated circuit (OPA PIC) that includes optical power splitters that distribute an optical signal from a laser, optical-fiber coupled to the chip or integrated on the chip, tunable optical delay lines for phase control and integrated optical amplifiers to increase optical power. The delay lines direct their output optical signals to structures, such as optical emitters, mirrors, gratings, laser diodes, light scattering particles and the like. The structures establish out-of-plane coupling of light.

Phase tuners (e.g., 106) establish phase delays to form a desired far field radiation pattern through the interference of emitted beams. Phase shifting may be implemented with any number of configurations of phase shifting optical devices, including, but not limited to: gain elements, all-pass filters, Bragg gratings, dispersive materials, wavelength tuning and phase tuning. When phase tuning is used, the actuation mechanisms used to tune delay lines, and optical splitters when they are tunable, can be any of a variety of mechanisms, including but not limited to: thermo-optic actuation, electro-optic actuation, electro-absorption actuation, free carrier absorption actuation, magneto-optic actuation, liquid crystal actuation and all-optical actuation.

In one embodiment, the vertical dimension (i.e., the dimension perpendicular to the steering direction) of the spot size is reduced with at least one on-chip grating or at least one off-chip lens. Types of off-chip lens include but are not limited to: refractive lens, graded-index lens, a diffractive optical element and a holographic optical element. The disclosed techniques are applicable to two-dimensional optical phased arrays where the beam can be steered in any direction.

In a time of flight lidar application, the OPA-based lidar includes an optical transmitter (including laser, laser driver, laser controller, OPA PIC, and OPA controller), an optical receiver (including photodetector(s), photodetector drivers, and receiver electronics), and electronics for power regulation, control, data conversion, and processing.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
an optical phased array producing a far field electro-magnetic field defining a field of view;
receivers to collect reflected electro-magnetic field signals characterizing the field of view; and
a processor configured to process the reflected electro-magnetic field signals to identify a selected area in the field of view as an area of interest, the processor further configured to dynamically adjust control signals applied to the optical phased array to produce an updated far field electro-magnetic field with increased electro-magnetic field resolution for the selected area.

2. The apparatus of claim 1 wherein the far field electro-magnetic field is a sweep field formed from a signal firing pattern with constant angular resolution between adjacent emitted signals.

3. The apparatus of claim 2 wherein the updated far field electro-magnetic field is a focus field that includes additional signals in the selected area with an angular resolution between adjacent emitted signals that is less than the constant angular resolution.

4. The apparatus of claim 3 wherein the ratio between the sweep field and the focus field within a frame is variable and dynamic.

5. The apparatus of claim 1 wherein the processor identifies the selected area based upon different time of flight values between adjacent reflected electro-magnetic field signals.

6. The apparatus of claim 1 wherein the processor dynamically adjusts control signals applied to the optical phased array to produce a far field electro-magnetic field with an arbitrary pattern.

7. The apparatus of claim 1 wherein the far field electro-magnetic field is a two dimensional electro-magnetic field.
